(19) United States
(12) Patent Application Publication
(10) Pub. No.: US 2006/0083448 A1
(43) Pub. Date: Apr. 20, 2006

(54) Compact compliant centering support for squeeze film damper

(75) Inventors: Mohsiul Alam, Chandler, AZ (US); Doug K. Spencer, Mesa, AZ (US); Shari L. Charleston, Scottsdale, AZ (US); Paul B. Talbert, Phoenix, AZ (US); Edward M. Jankowich, Tempe, AZ (US); Matthew D. Johnson, Phoenix, AZ (US)

Correspondence Address: Honeywell International, Inc., Law Dept. AB2, P.O. Box 2245, Morristown, NJ, 07962-9806, US

(73) Assignee: Honeywell International Inc., Morristown, NJ (US)

(21) Appl. No.: 10/967,979

(22) Filed: Oct. 19, 2004

(51) Int. Cl. F16C 27/00

(52) U.S. Cl. 384/99

(57) ABSTRACT

The present invention provides a centering feature to the bearing assembly of a turbomachine to provide optimum operating characteristics of the squeeze film damper. Unlike conventional bearing centering methods and apparatus, a compact compliant centering support for the squeeze film damper interfaces between a bearing outer race, and an outer support structure. The compact design is lightweight and inexpensive, can be retrofitted easily to an existing turbomachine, such as a turbine and compressor, for improved rotor dynamic performance. The compact compliant centering support damper may be comprised of a ring with bumpers spaced around the circumference at the inside and outside diameters to form spring elements between the bumpers. The centering support may lift the rotor inside the squeeze film cavity and may eliminate rotor weight effect on the damper performance. The centering support may be offset in the vertical direction to center the rotor under 1 g deflection to eliminate rub at the 6 o'clock location of a compressor or turbine shroud. Tangential grooves may be provided on the centering support outer bumpers to allow oil to squeeze out when the centering support is deflected to provide additional viscous damping. The outer bumper height may be controlled to limit maneuver deflection of the rotor.

### BACKGROUND OF THE INVENTION

This invention relates to turbomachine, and more specifically, to the bearing support assembly that transmits the vibration force from the rotor assembly to the support structure.

A turbomachine includes rotating components such as a fan, a compressor, and a turbine. The components are clamped either by a shaft or by bolted flange joints into a rotor assembly. During high-speed rotation of this rotor assembly, forces are transmitted from the rotor assembly to the support structure. To damp the effect of these transmitted forces, a film of oil (“squeeze film”) may be confined between the rotor assembly and the support structure. The oil in the squeeze film is under pressure and acts as a damper. Adequate damping requires that the squeeze film not be too thick or too thin. The rotating rotor assembly may not remain concentric, with respect to the squeeze film cavity, because of rotor assembly movement during acceleration, deceleration, or steady state operation. To counteract the tendency for the rotating assembly to operate off center, thus compromising the performance of the squeeze film damper, various conventional designs attempt to use a centering feature to maintain a uniform squeeze film damper thickness.

While various conventional designs for the centering feature for the squeeze film damper have been proposed and used in turbomachines, improved designs are required for optimum operating characteristics such as to enhance modal damping, to provide compliance to the rotor dynamic system, to precisely place the rigid body modes outside the operating envelope, to minimize impact on component durability and cabin noise, to center the rotor to optimize compressor, fan, turbine blade clearances, to limit maneuver deflection, and to reduce vibration.

One such conventional design is disclosed in U.S. Pat. No. 6,626,574 to Bos, et al. (“Bos patent”). The Bos patent discloses a bearing for maintaining revolution symmetry of an inner mobile structural component. The bearing appears to comprise a squeeze film damper situated at an annular contact surface between an outer bearing race and an outer structural component. However, the Bos patent does not appear to disclose an apparatus or method for centering a rotor or eliminating maneuver deflection of the rotor. Furthermore, the Bos patent does not appear to disclose an apparatus or method for providing additional viscous damping.

As can be seen, there is a need for an improved apparatus and method for centering a squeeze film damper with simplified components (for example, less parts, less volume, lighter weight, and a more compact centering support). Furthermore, there is a need for an improved apparatus and method for rotatably supporting a rotor structure.

### SUMMARY OF THE INVENTION

In one aspect of the present invention, an apparatus for supporting a rotor assembly in a turbomachine comprises a shaft supported by a bearing assembly wherein the bearing assembly contains one rolling element; a centering support surrounding the bearing assembly with interior and an exterior bumpers; and a bearing support housing surrounding the bearing assembly and the centering support, comprising a bearing support assembly. The bearing support assembly may then be attached via a support structure (such as an engine case or frame) to the turbomachine.

In another aspect of the present invention, an apparatus for supporting a rotating assembly in a turbomachine comprises a shaft supported by at least two bearing assemblies, wherein the bearing assemblies each contain one rolling element, a centering support surrounding the bearing assembly, with an exterior bumper and an interior bumper; and a bearing support housing surrounding the bearing assemblies and the centering support, comprising a bearing support assembly. The bearing support assembly may then be attached via the support structure to the turbomachine.

In another aspect of the present invention, an apparatus for supporting a rotor assembly in a turbomachine comprises a shaft supported by a bearing assembly, containing a rolling element, an inner race, and an outer race, a centering support, surrounding the bearing assembly with an exterior bumper and an interior bumper; and a bearing support housing surrounding the bearing assembly; and the centering support comprising a bearing support assembly. The bearing support assembly may then be attached via the support structure to the turbomachine.

In a further aspect of the present invention, an apparatus for supporting a rotor assembly in a turbomachine comprises a shaft supported by at least two bearing assemblies, wherein the bearing assemblies each contain one rolling element, an inner race, and an outer race; a centering support surrounding the bearing assemblies, with exterior and interior bumpers. In this aspect of the present invention a squeeze film damper may be located in parallel with the centering support, between the bearing assembly outer diameter and the bearing support housing inner diameter, with an oil supply provision contained therein for the delivery of lubricant through an annular groove to the squeeze film damper. The bearing support assembly may then be attached via the support structure to the turbomachine.

In yet a further aspect of the present invention, a method for rotatably supporting a rotor assembly with a support structure comprises mounting a bearing assembly for supporting a rotor assembly within a movable member; suspending the movable member from the support structure upon at least two bearing assemblies; establishing a squeeze film damper between the movable member and the support structure; and centering the movable member with a centering support, wherein the centering support comprises exterior bumpers and interior bumpers.

These and other aspects, objects, features and advantages of the present invention, are specifically set forth in, or will become apparent from, the following detailed description of a preferred embodiment of the invention when read in conjunction with the accompanying drawings.

### BRIEF DESCRIPTION OF THE DRAWINGS

FIG. 1 is a cross sectional view of a turbomachine, according to an embodiment of the present invention;

FIG. 2 is an isometric view of the centering support of FIG. 1;

FIG. 3 is an expanded view of Area A of the centering support of FIG. 2; and

FIG. 4 is a flow chart of a method for rotatably supporting a rotor structure, according to an embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention provides a centering feature to the bearing of a turbomachine (such as found in aircraft, land vehicles, space craft, generation equipment, and other high speed rotating equipment uses) that eliminates unstable vibrations and dampens synchronous vibrations. Unlike conventional designs that use heavyweight components to center the squeeze film damper, the present invention provides a compact compliant centering support for the squeeze film damper interfaces between a component, such as a bearing assembly outer race, and an outer support structure (such as an engine case or frame).

The compact design of the present invention may be lightweight and inexpensive and may be retrofitted easily to an existing turbomachine, such as a turbomachine, for improved rotor dynamic performance. The compact compliant centering support squeeze film damper may be comprised of a ring with bumpers spaced around the circumference at the inside and outside diameters to form spring elements between the bumpers. The centering support may lift the rotor inside the squeeze film damper cavity and may eliminate rotor weight effect on the damper performance. The centering support may be situated between a bearing support housing and an outer race of a roller or ball bearing. The ring may be offset in the vertical direction to center the rotor under 1 g deflection to eliminate a rub at the 6 o'clock location of a rotating component shroud. Tangential grooves may be provided on the outer bumpers to allow oil to squeeze out when the ring is deflected to provide additional viscous damping. The outer bumper height may be controlled to limit maneuver deflection of the rotor.

The present invention further provides an apparatus for supporting a rotor assembly in a turbomachine comprising a shaft supported by a bearing assembly, a centering support surrounding the bearing assemblies, with exterior and interior bumpers and a bearing support housing surrounding the bearing assemblies and the centering support comprising a bearing support assembly. The support apparatus of the present invention is unlike a conventional supporting apparatus that lacks an apparatus or method for centering a rotor or eliminating maneuver deflection of the rotor. The conventional support apparatus also does not comprise a structure for additional viscous damping, such as the tangential grooves of the present invention.

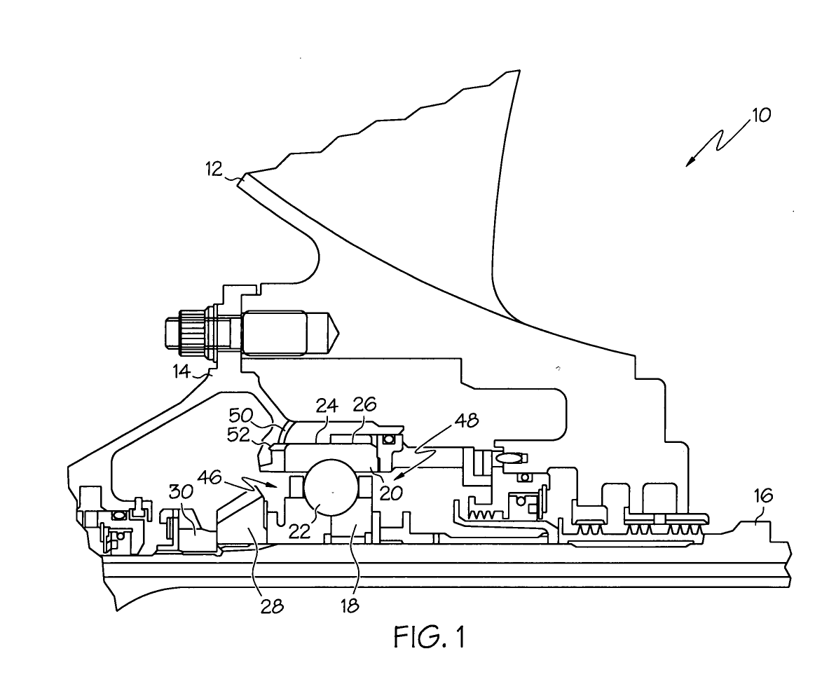

The bearing support assembly is then attached via the support structure to the turbomachine. In more specifically describing the present invention and as can be appreciated from FIG. 1, the present invention provides a turbomachine 10, such as a compressor and turbine, or a turbocharger, which may be located aboard an aircraft, missile, spacecraft, tank, turbocharger, and the like. A bearing support housing 14 may be connected to a support structure 12 via pilots, studs and nuts (not shown). The bearing support housings 14 may surround two or more bearing assemblies 46 and the bearing support housing 14 may accommodate a squeeze film damper 24 in parallel with a centering support 26 and may have an oil supply provision 50 for the delivery of lubricant (such as oil) through an annular groove 52 to a squeeze film damper 24. Two or more bearing assemblies 46 may support a shaft 16. The bearing assembly 46 may include a rolling element 22, such as a ball or a roller, an inner race 18, and an outer race 20. The inner race 18 may be fixed to the shaft 16. The centering support 26 may be situated between the bearing support housing 14 and the outer race 20 of the bearing assembly 46, including a bearing support assembly 48. The bearing assembly 46 may be positioned with a nut 30 and a bevel gear 28 for securing the bearing assembly 46 from axial movement. The bearing assembly 46 may be clamped by a nut 30 to the shaft 16. The centering support 26 may circumscribe the outer race 20 of the bearing assembly 46. The centering support 26 may be comprised of a material, such as steel, aluminum, or titanium.

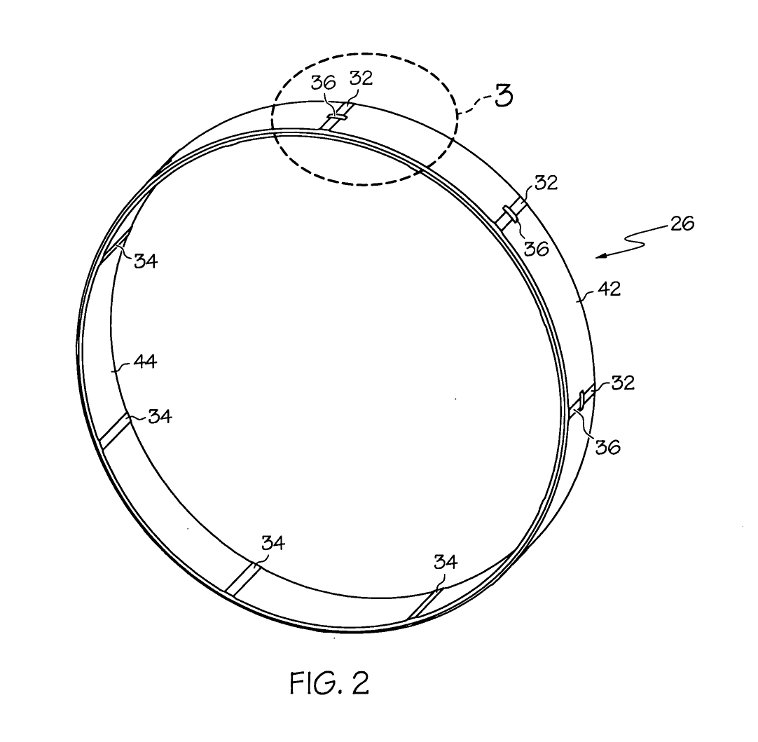

The centering support 26 may be seen in isolation in FIG. 2. The centering support 26 may comprise exterior bumpers 32 along an outer surface 42 of the centering support 26 and interior bumpers 34 along an inner surface 44 of the centering support 26. The exterior bumpers 32 may be situated within the bearing support housing 14 (shown in FIG. 1) with an interference fit. The interior bumpers 34 may be ground (for example, by a grinding machine) to provide a vertical offset of a shaft 16 (shown in FIG. 1) centerline to accommodate deflection due to the weight of the shaft 16. This offset feature permits the turbomachine to operate concentric to the centerline of the bearing support housing 14.

Tangential grooves 36 may be cut into the exterior bumpers 32 to permit oil passage during ring deflection so that oil may be squeezed outward to add additional viscous damping to the squeeze film damper 24. Each groove 36 may be perpendicular to the respective exterior bumper 32 and each groove 36 may be parallel to a direction of rotation of the shaft 16.

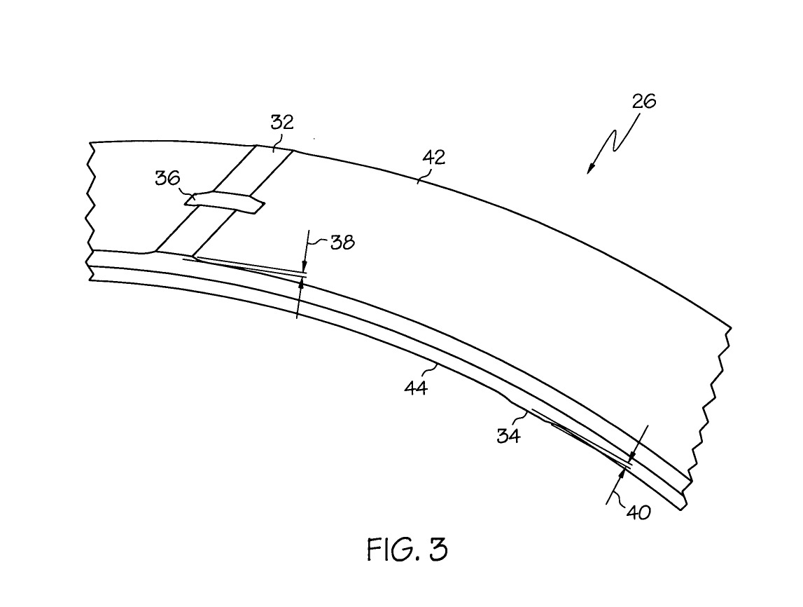

FIG. 3 shows an enlarged view of Section A of FIG. 2. An exterior bumper height 38 may be measured from the outer surface 42 of the centering support 26 to the distal end of the exterior bumper 32. For example, the exterior bumper 32 may have an exterior bumper height 38 from about 0.006 inch (0.01524 cm) to about 0.008 inch (0.02032 cm). Often, the exterior bumper height 38 may be from about 0.006 inch (0.01524 cm) to about 0.008 inch (0.02032 cm). An interior bumper height 40 may be measured from the inner surface 44 of the centering ring 26 to the distal end of the interior bumper 34. For example, the interior bumper 34 may have an interior bumper height 40 of about 0.007 inch (0.01778 cm). Often the interior bumper 34 may have an interior bumper height 40 from about 0.00745 inch (0.01892808 cm) to about 0.007785 inch (0.008702 cm).

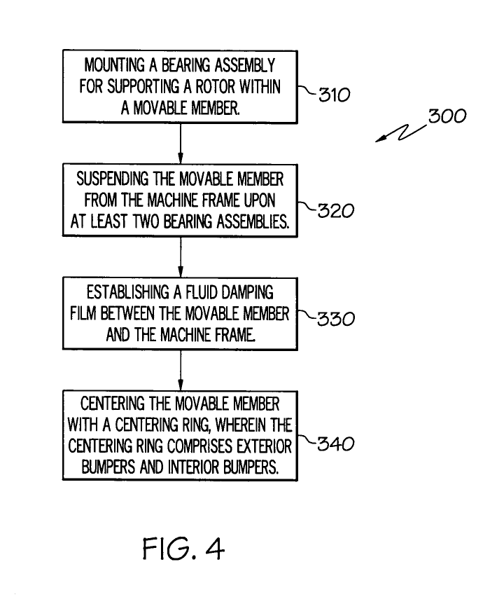

With reference to FIG. 4, a method 300 for rotatably supporting a rotor assembly with a support structure 12 may comprise a step 310 of mounting a bearing assembly 46 for supporting a shaft 16 within a movable member. Next, a step 320 may comprise suspending the movable member from the support structure 12 upon at least two bearing assemblies 46. A step 330 may comprise establishing a squeeze film damper between the movable member and the support structure 12 and a step 340 may comprise centering the movable member with a centering support 26, wherein the centering support 26 may comprise exterior bumpers 32 and interior bumpers 34.

It should be understood, of course, that the foregoing relates to exemplary embodiments of the invention and that modifications may be made without departing from the spirit and scope of the invention as set forth in the following claims.

We claim:

1. An apparatus for supporting a rotor assembly in a turbomachine, comprising:
a shaft supported by a bearing assembly;
a centering support surrounding said bearing assembly and comprising an exterior bumper and an interior bumper; and
a bearing support housing surrounding said bearing assembly.

2. The apparatus of claim 1, wherein the exterior bumper has an exterior bumper height from about 0.006 inch (0.01524 cm) to about 0.008 inch (0.02032 cm).

3. The apparatus of claim 1, wherein the exterior bumper has an exterior bumper height from about 0.006 inch (0.01524 cm) to about 0.007 inch (0.01778 cm).

4. The apparatus of claim 1, wherein the interior bumper has an interior bumper height of about 0.007 inch (0.01778 cm).

5. The apparatus of claim 1, further comprising a groove in the exterior bumper.

6. The apparatus of claim 5, wherein the groove is parallel to a direction of rotation of said shaft.

7. An apparatus for supporting a rotor assembly in a turbomachine, comprising:
a shaft supported by at least two bearing assemblies, wherein each of said bearing assemblies contain one rolling element, an inner race, and an outer race;
a centering support surrounding said bearing assemblies and comprising exterior bumpers and interior bumpers; and
a bearing support housing surrounding said bearing assemblies and said centering support.

8. The apparatus of claim 7, wherein the turbomachine comprises a compressor.

9. The apparatus of claim 7, wherein the turbomachine comprises a turbine.

10. The apparatus of claim 7, wherein the exterior bumpers have an exterior bumper height from about 0.006 inch (0.01524 cm) to about 0.007 inch (0.01778 cm).

11. The apparatus of claim 7, wherein the interior bumpers have an interior bumper height of about 0.007 inch (0.01778 cm).

12. The apparatus of claim 7, wherein said inner race of each of said bearing assemblies is fixed to said shaft.

13. The apparatus of claim 7, wherein said bearing assemblies are clamped by a nut to said shaft.

14. The apparatus of claim 7, further comprising grooves in the exterior bumpers.

15. An apparatus for supporting a rotor assembly in a turbomachine, comprising:
a shaft supported by at least two bearing assemblies, wherein each of said bearing assemblies contains one rolling element, an inner race, and an outer race;
a centering support surrounding said bearing assembly and comprising exterior bumpers and interior bumpers; and
a bearing support housing surrounding said bearing assemblies and centering support, wherein said bearing support housing accommodates a squeeze film damper in parallel and has an oil supply provision contained therein for the delivery of oil through an annular groove to the squeeze film damper.

16. The apparatus of claim 15, wherein said inner race of said bearing assembly is fixed to said shaft.

17. The apparatus of claim 15, wherein said bearing assembly is clamped by a nut to said shaft.

18. The apparatus of claim 15, wherein said centering support is situated between said bearing support housing and said outer race of the bearing assemblies.

19. The apparatus of claim 15, wherein said inner race is fixed to said shaft.

20. The apparatus of claim 15, further comprising grooves in the exterior bumpers.

21. The apparatus of claim 20, wherein the grooves are parallel to a direction of rotation of said shaft.

22. The apparatus of claim 15, wherein the turbomachine comprises a compressor.

23. The apparatus of claim 15, wherein the turbomachine comprises a turbine.

24. A turbine engine, comprising:
a support structure;
a shaft enclosed within said engine case and supported by a bearing assembly;
a centering support, wherein the centering support comprises exterior bumpers and interior bumpers and the centering support circumscribes an outer race of said bearing assembly; and
a bearing support housing surrounding said bearing assembly and connected to said support structure.

25. The turbine engine of claim 24, wherein said shaft is supported by at least two bearing assemblies.

26. The turbine engine of claim 24, further comprising a nut for attaching said bearing assembly to said bearing support housing.

27. The turbine engine of claim 24, wherein the exterior bumpers have an exterior bumper height from about 0.006 inch (0.01524 cm) to about 0.007 inch (0.01778 cm).

28. The turbine engine of claim 24, wherein the interior bumpers have an interior bumper height of about 0.007 inch (0.01778 cm).

29. The turbine engine of claim 24, further comprising grooves in the exterior bumpers.

30. A method for rotatably supporting a rotor assembly with a support structure, comprising:
mounting a bearing assembly for supporting a rotor assembly within a movable member;
suspending the movable member from the support structure upon at least two bearing assemblies;
establishing a squeeze film damper between the movable member and the support structure; and
centering the movable member with a centering support, wherein the centering support comprises exterior bumpers and interior bumpers.

31. The method of claim 30, further comprising grooves in the exterior bumpers.

32. The method of claim 31, wherein the grooves are parallel to a direction of rotation of said movable member.
